(19) United States
(12) Patent Application Publication
(10) Pub. No.: US 2002/0116413 A1
(43) Pub. Date: Aug. 22, 2002

(54) System and method for on-line definition of web pages

(75) Inventor: John Rudolf Clark, Plymouth, MN (US)

Correspondence Address: MERCHANT & GOULD PC, P.O. BOX 2903, MINNEAPOLIS, MN, 55402-0903, US

(73) Assignee: Serbus, LLC,

(21) Appl. No.: 09/785,747

(22) Filed: Feb. 16, 2001

(51) Int. Cl. G06F 17/21

(52) U.S. Cl. 707/513; 707/517

(57) ABSTRACT

Disclosed herein is an invention that relates generally to a system and method for providing an on-line forum that permits a user to define a web page. The system enables a user who is unskilled in the development of web pages to be able to define his own web page, within the constraints of a general template.

The system provides an on-line forum for permitting at least one user to define a web page. The web page comprises a plurality of web page elements. The system includes a computing complex accessible to the user via a network. The computing complex has at least one processing node and at least one storage medium, and the processing node is programmed to cooperate with the storage medium to provide: a database that stores data describing at least one of the web page elements; and, a first software module designed to produce a template representing the web page. The template consists of a plurality of template elements, each of which corresponds to one of the web page elements, and some of which are selectable. The first software module is also designed to permit redefinition of a web page element corresponding to a template element, in response to the template element being selected.

FIG. 7 depicts a template web page in which some of the elements are non-definable with respect to a particular user.

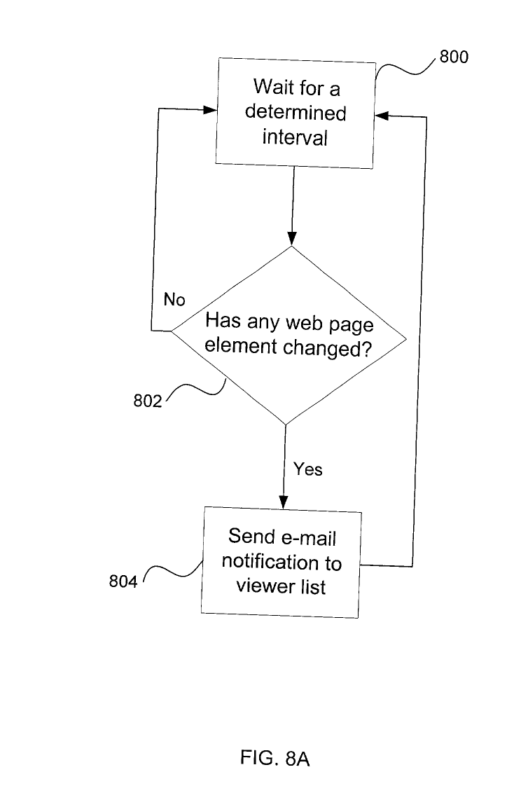

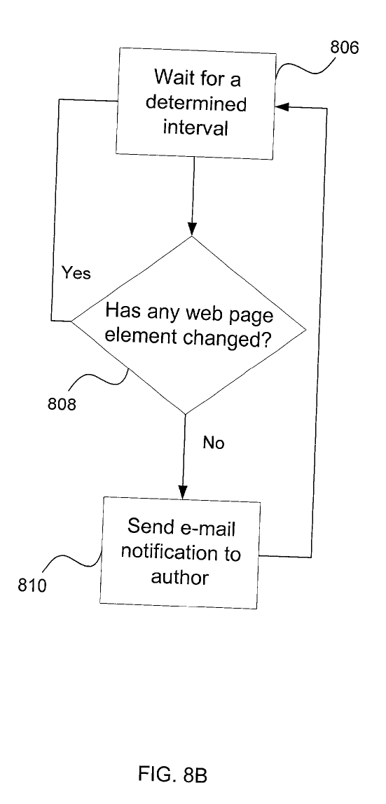

FIG. 8A depicts a sequence of steps to inform potential viewers of the affiliate web page that the page has been changed.

FIG. 8B depicts a sequence of steps to notify a user that his affiliate page has not been changed for an extended period of time.

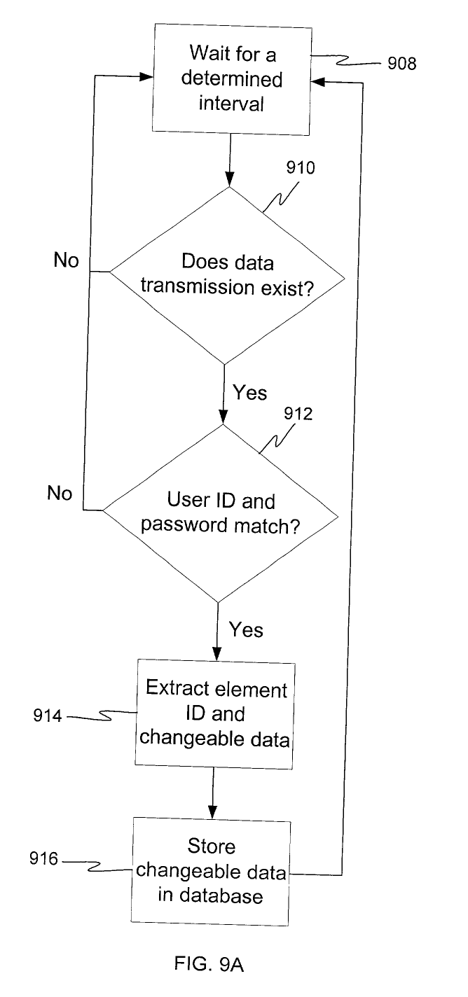

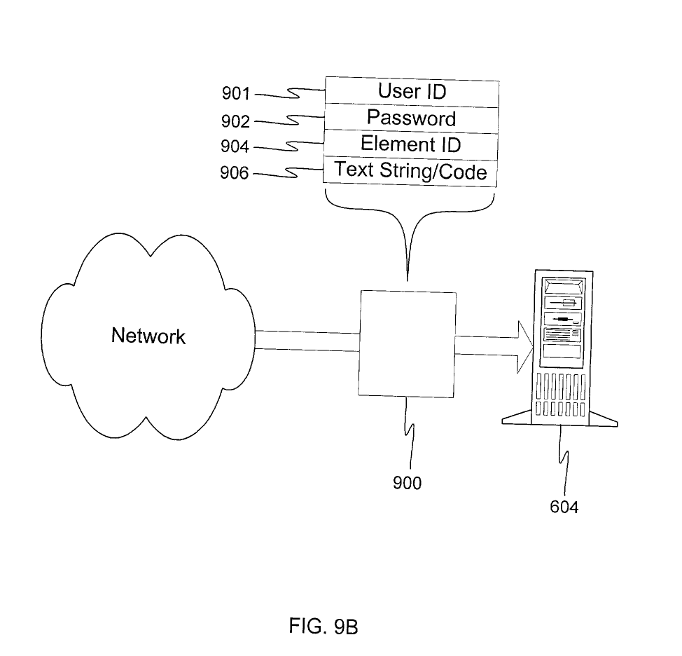

FIG. 9A depicts a sequence of steps that permit a user to transmit an unprompted data transmission to re-define an affiliate web page.

FIG. 9B depicts one example of an unprompted data transmission that is used to re-define an affiliate web page.

### DETAILED DESCRIPTION

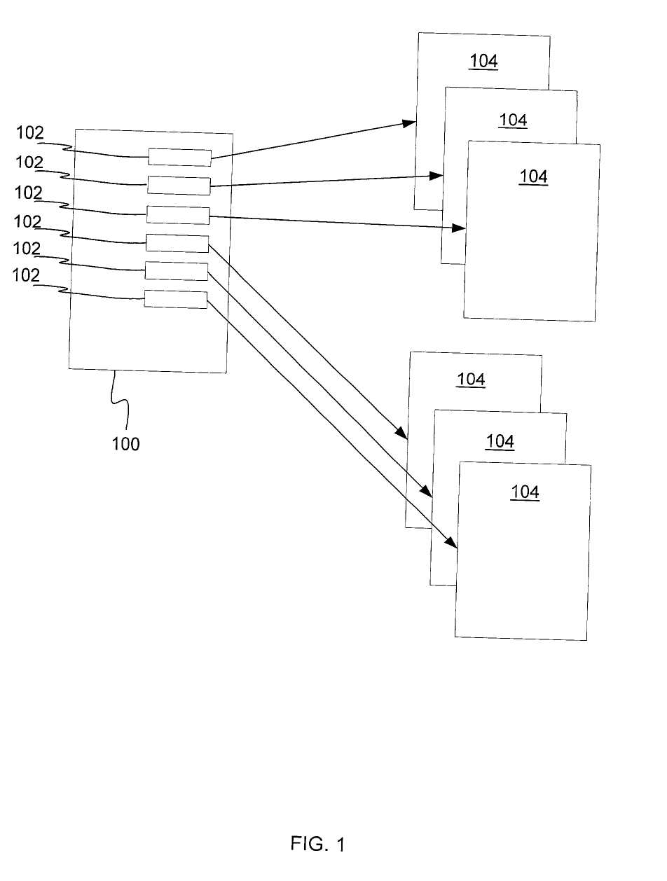

Many forms of organizations and businesses host web sites that serve as portals to employee or affiliate web pages. For example, an accounting firm may have a web site that introduces the firm generally and links to individual pages for each of its accountants, so that each accountant can describe himself and his practice more fully on his or her own web page. FIG. 1 illustrates this principle. As can be seen from FIG. 1, a main web site 100 (such as might be used to inform the public about an accounting firm) maintains a set of links 102 to various other web pages 104. Each web page 104 may be associated with an affiliate or employee of the entity administering the main web site 100 (for example, each of the various other web pages 104 may be associated with a particular accountant working for the accounting firm). Each of the various linked-to web pages 104 is referred to herein as an “employee web page” or an “affiliate web page”.

Because each of the affiliate web pages 104 may be individually associated with the organization/business hosting the main web site 100, it may be desirable for each affiliate web page 104 to have some generally common look-and-feel. For example, if the main web page 100 is hosted by an accounting firm, the accounting firm may insist that each of its accountant's personal web pages (such as affiliate web pages 104) have a common banner, common background, etc.

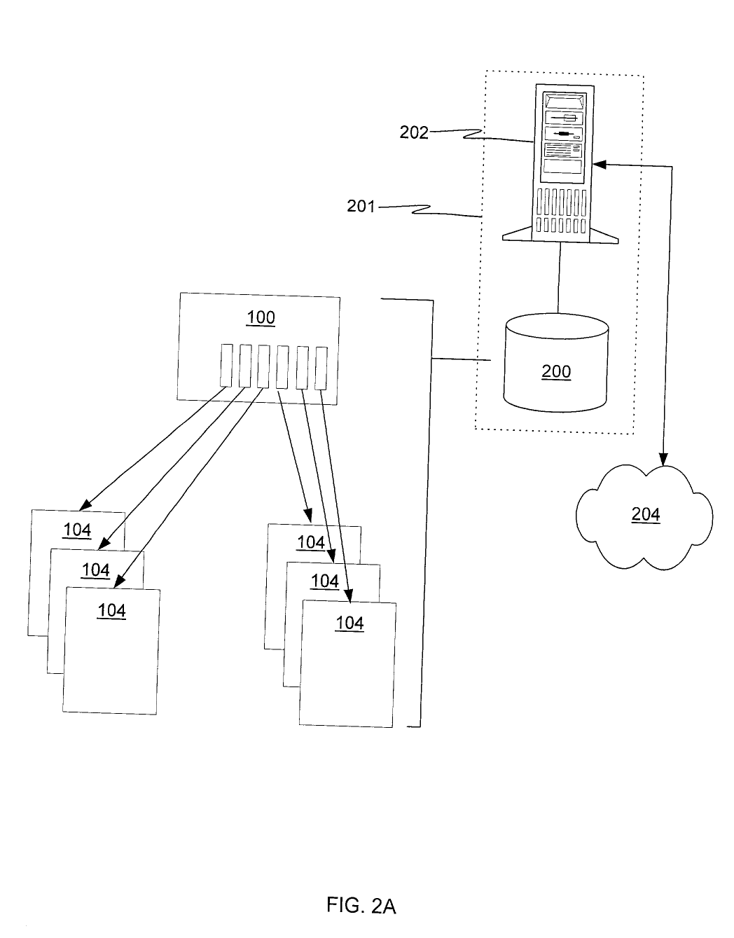

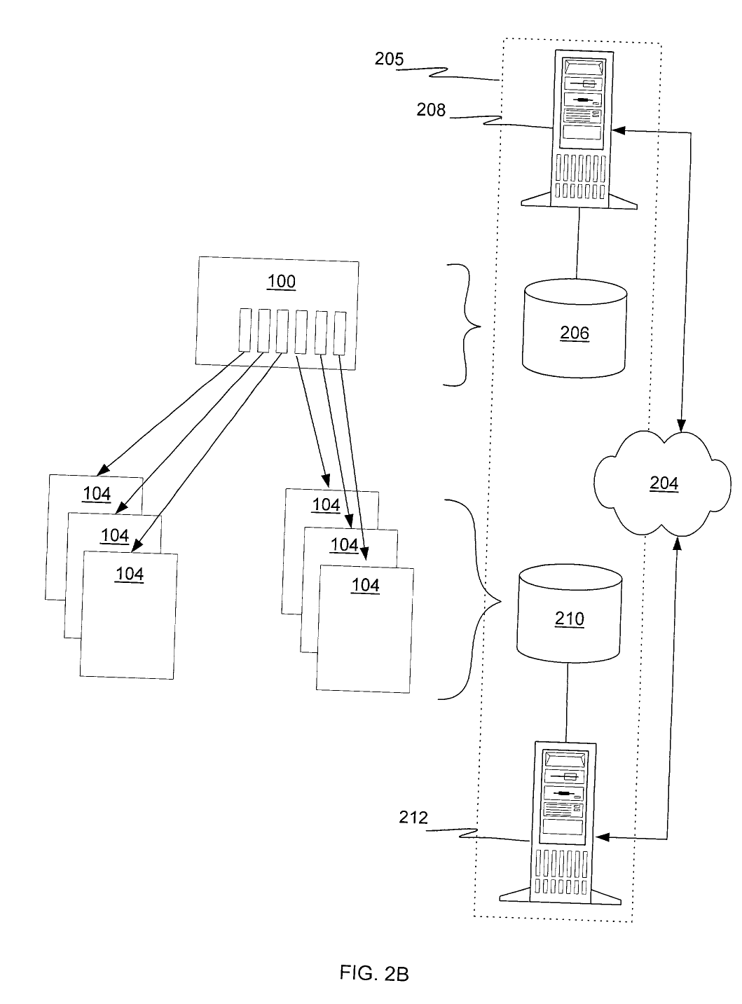

FIG. 2A depicts one exemplary computing complex 201 that may store and make available the main web site 100 and its linked-to affiliate web pages 104. The main web site 100 and its linked-to affiliate web pages 104 may be embodied in a semanitc representation (such as HTML, DHTML, XML, CFML, or any other suitable markup language) saved in a storage facility 200, which is available to a processing node (also referred to herein as a “server”) 202. Computing complex 201 comprises storage facility 200 and processing node/server 202. The storage facility 200 may actually consist of multiple storage units, such as an array of hard disc drives. The processing node 202 may consist of more than one processing node/server, all of which cooperate to perform web page hosting activities. Processing node 202 is accessible via a network 204. Network 204 may be a local area network, wide area network (such as the Internet), metropolitan area network, or any other suitable form of network. Thus, the main web page 100 and its linked-to affiliate web pages 104 can be made available to those having access to the network 204.

FIG. 2B depicts another exemplary computing complex 205 that may store and make available the main web site 100 and its linked-to affiliate web pages 104. As in the system depicted in FIG. 2A, the main web site 100 may be embodied in a semantic representation saved in a storage facility 206, which is available to a processing node/server 208. Processing node/server 208 may consist of more than one processing node/server, all of which cooperate to perform web page hosting activities. Similar to storage facility 200 of FIG. 2A, storage facility 206 may actually consist of multiple storage units. The processing node/server 208 is linked to the network 204. Also linked to the network 204 is processing node/server 212 (processing node/server 212 may also consist of more than one processing node/server, all of which cooperate to perform web page hosting activities), which stores and retrieves data from storage facility 210. Storage facility 210 may actually consist of multiple storage units, such as an array of hard disc drives, and has stored within it semantic representations of the affiliate web pages 104. Thus, the main web page 100 is made available to the public via a first processing node/server 208, and the employees'/affiliates' web pages 104 are made available via a second processing node/server 212.

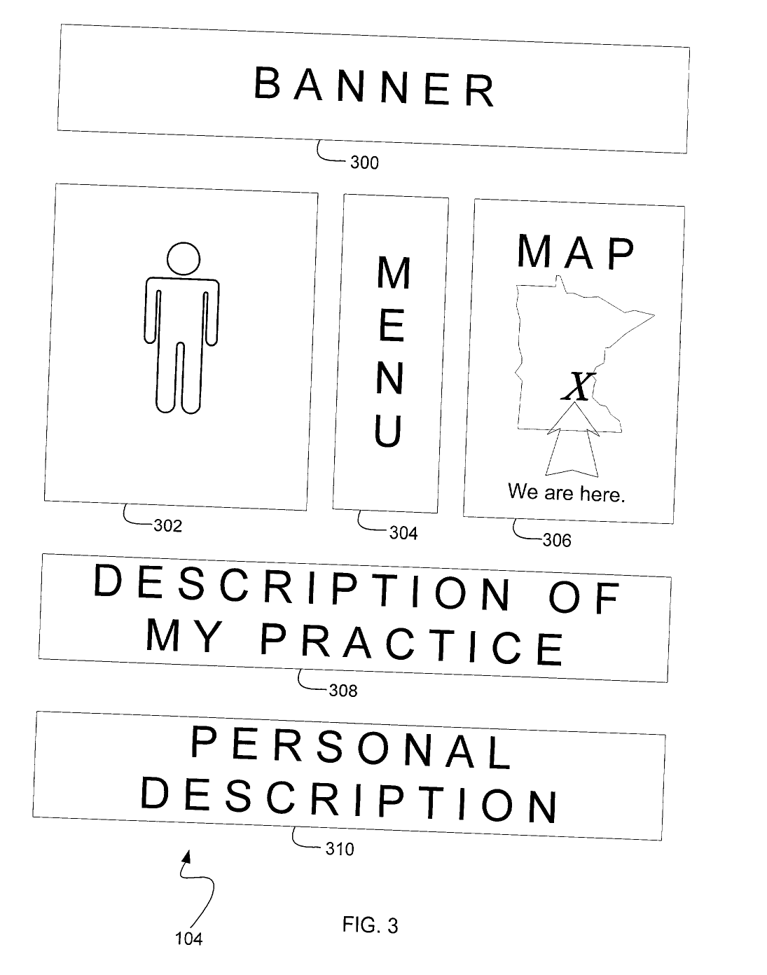

FIG. 3 depicts an example of an affiliate web page 104. Employee/affiliate web page 104 could take on many embodiments, and the particular embodiment disclosed in FIG. 3 is for the illustrative purposes only. The employee web page 104 is comprised of one or more web page elements. A web page element is a component of a web page (i.e., a link, an image, a string of text, etc.). For example, the affiliate web page 104 has a banner 300 running across its top. The banner 300 may be used to identify the business/organization with which the custodian of the web page 104 is associated (i.e., the custodian of the affiliate web page is an an accountant, the organization/business is an accounting firm, and the banner 300 identifies the accounting firm). The banner 300 is one example of a web page element (although, it is possible to contstruct the banner from more than one web page element). Employee/affiliate web page 104 also contains a picture 302 of the employee/affiliate (a picture of a particular accountant, for example), which is another example of a web page element. The exemplary web page 104 also includes a menu 304. The menu 304 contains links to other portions of the web page 104 or to other web pages. Additionally, the web page 104 may contain a map 306, which identifies the location of the employee/affiliate office. Finally, the web page 104 also possesses a description of a particular employee's/affiliate's practice 308 (for example, a description of a particular accountant's practice) and a personal description of a particular employee/affiliate 310 (for example, a personal description of a particular accountant).

The affiliate web page 104 of FIG. 3 may be used generally by each employee/affiliate of a business/organization. For example, each accountant in an accounting firm could use the web page 104 of FIG. 3 to describe himself and his practice. As a result, each employee web page would have a similar look-and-feel. Each employee web page would have a banner 300, a picture of the accountant 302, a personal description 310, and so on. Thus, each affiliate web page 104 consists of the same sort of web page elements, but the individual information comprising each web page element would be modified to describe the particular accountant. For example, to personalize a page, each employee would define his page by including his own picture, his own personal description, etc.

Some web page elements may be identically reproduced in each affiliate web page 104. For example, with regard to the affililiate web page 104 of FIG. 3, the banner 300, the menu 304, and the map 306 may appear on every employee web page in exactly the same manner (i.e., an accounting firm might want each of its accountants to use exactly the same banner, exactly the same map to identify the location of the office, and to provide exactly the same set of links via a menu). Accordingly, with respect to each employee, some web page elements may be classified as definable (for example, the picture 302, description of practice 308, and personal description 310) and others as non-definable (for example, the banner 300, the menu 304, and the map 306).

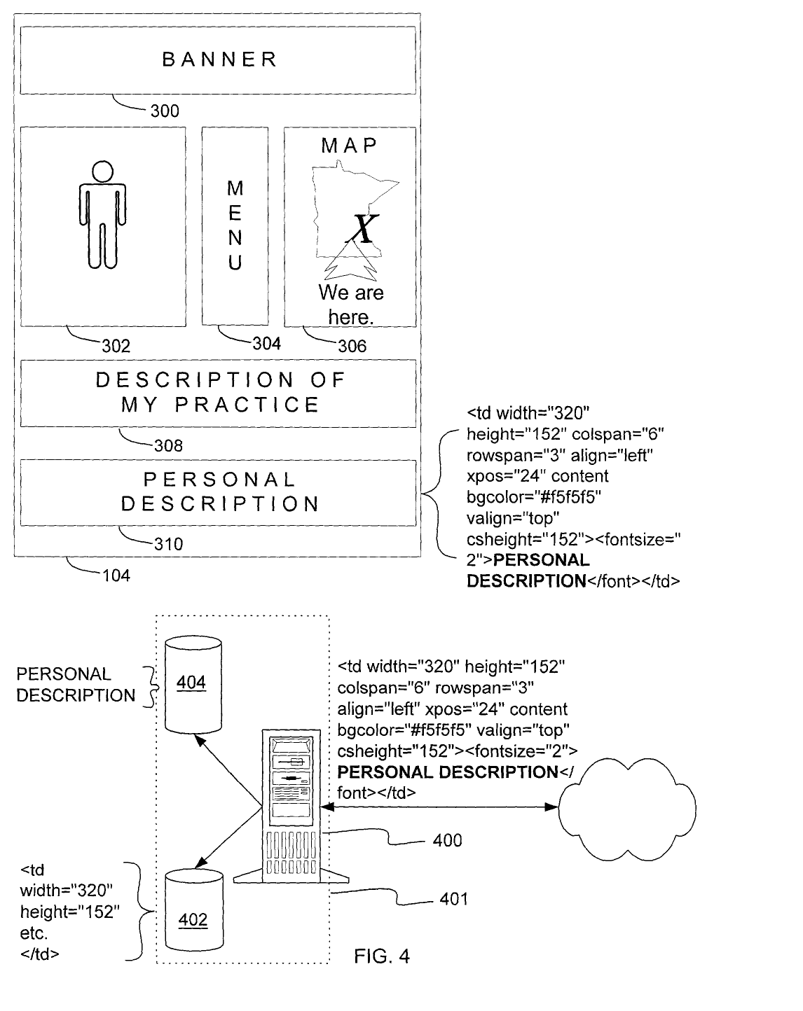

FIG. 4 illustrates the idea that a semantic representation of a definable web page element can be divided into user-definable and non-user-definable portions. FIG. 4 also illustrates a computing complex that can combine the user-definable and non-user-definable portions of a semantic representation of a definable web page element, thus creating a semantic representation of a web page in an element-by-element fashion.

The personal description 310 web page element (on the affiliate web page 104) is an example of a user-definable web page element. It is user-definable because at least one aspect of that element can be changed—in this case, the text can be changed (the means by which it can be changed will be discussed below). Accordingly, the textual component making up the semantic representation of the personal description 310 web page element is user-definable.

Assuming the personal description 310 web page element was created using HTML as the particular form of semantic representation (and assuming it was created as a data entry within a table), the semantic representation could read:

<td width=“320” height=“152” colspan=“6” rowspan=“3”

align=“left” xpos=“24” content bgcolor=“#f5f5f5”

valign=“top” csheight=“152”><font size=“2”>PERSONAL

DESCRIPTION</font></td>

Such a semantic representation has both user-definable and non-user definable portions. The portion reading “PERSONAL DESCRIPTION” (i.e., the textual aspect of the web page element) is definable. The other portions, such as the portion reading “<td width=“320” height=“152” colspan=“6” rowspan=“3” align=“left” xpos=“24” content bgcolor=“#f5f5f5” valign=“top” csheight=“152”>” (i.e., the portions defining the appearance of the text, the location of the text, etc.) are non-user-definable.

The computing complex 401 of FIG. 4 can be used to combine the user-definable and non-user-definable components, thus creating a semantic representation of the affiliate web page 104. The computing complex of FIG. 4 possesses a computing node 400 and two storage facilities 402 and 404. Although the computing node 400 is depicted as a single computing node, computing node 400 can consist of several computing nodes working in concert. Storage facility 402 and 404 are both available to computing node 400. Storage facility 402 stores non-user-definable components, and storage facility 404 stores the user-definable components. Computing node 400 is programmed to draw the non-user-definable components from the storage facility 402 and the user-definable components from storage facility 404 and combine them into a single semantic representation. For example, with respect to the employee/affiliate web page 104, the text string “PERSONAL DESCRIPTION” would be stored in storage facility 404, while the other components were stored in storage facility 402. When serving the employee/affiliate web page 104 to a web client, the processing node 400 combines the non-user-definable components (“<td”, “width=“320””, etc) and the user-definable components (“PERSONAL DESCRIPTION”) into the afore-stated semantic representation.

Storage facilities 402 and 404 need not be separate physical devices. Storage facilities 402 and 404 may be embodied by a single storage unit that stores user-definable and non-user-definable web page components. Alternatively, storage facility 404 could be embodied by a database storing user-definable components, while storage facility 402 is embodied by a set of dynamic semantic representations of web pages (a dynamic semantic representation of web pages is a semantic representation of a web page that requires that certain aspects of the page be defined at run-time, such as CFML or DHTML).

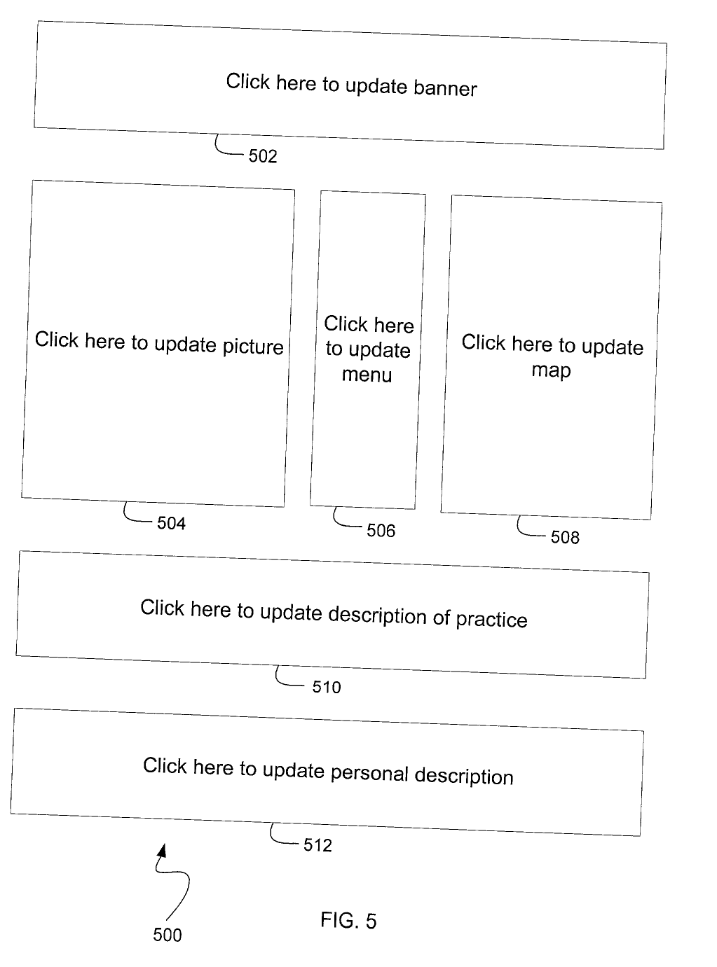

FIG. 5 depicts a template 500 of the affiliate web page 104. The template 500 can be used as a user interface to permit a user to edit user-definable portions of a semantic representation of a web page element stored in the storage facility 404. The template 500 has a set of template elements, each of which corresponds to the web page elements comprising the affiliate web page 104. Like the affiliate web page 104, the template 500 also has a banner template element 502, a picture template element 504, a menu template element 506, a map template element 508, a practice description template element 508, and a personal description template element 510. The template 500 is viewable via a web browser, taking on the form of a web page in the likeness of the affiliate web page 104 (i.e., a template web page looks like a blank version of the web page for which it is a template). In response to selection of a template element, a user is prompted to change the definable aspect of the web page element corresponding to the selected template element. For example, if the personal description template element 510 were to be selected, a window is opened prompting the user to change the text of the personal description web page element 310 from “PERSONAL DESCRIPTION” to whatever is desired (upon selection of a template element, the user is prompted to change any user-definable component of the associated web page element). In response, the new text is stored in storage facility 404. Thus, when computing node 400 next combines the user-definable and non-user-definable components to create a semantic representation of the affiliate web page 104, the new text appears.

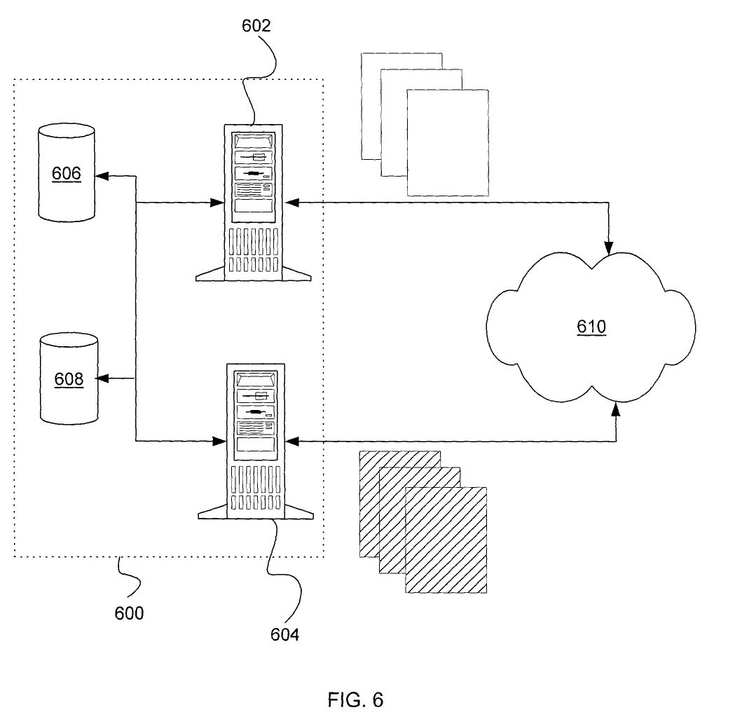

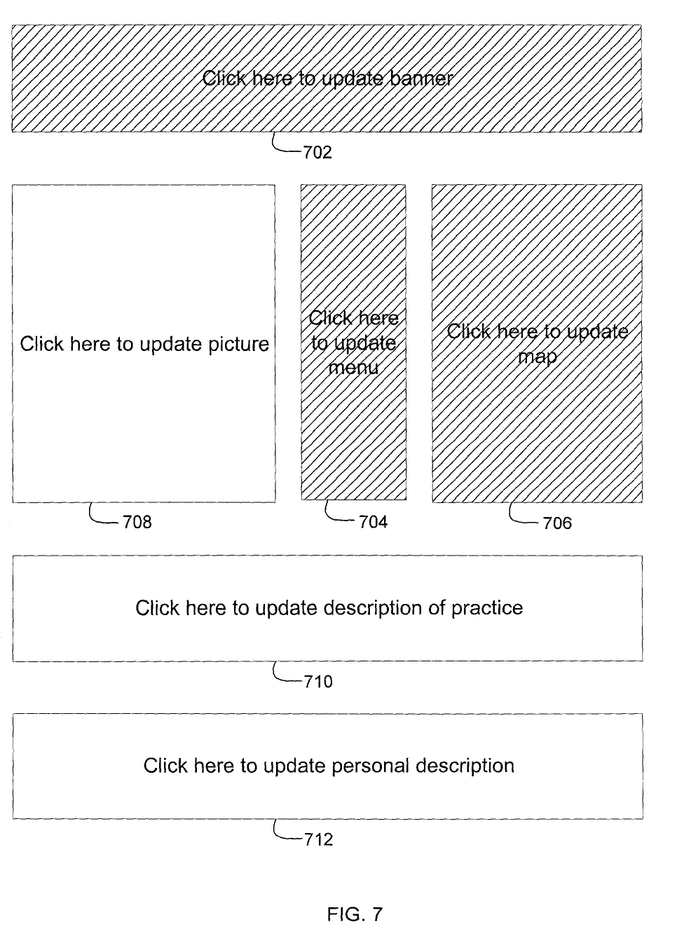

FIG. 6 depicts a system that generates affiliate web pages and also generates their corresponding template web pages. The computing complex 600 shown in FIG. 6 is composed of two processing nodes 602 and 604 and two storage facilities 606 and 608. Processing nodes 602 and 604 are each in communication with storage facilities 606 and 608. Processing nodes 602 and 604 are accessible via network 610. Storage facility 606 stores user-definable portions of semantic representation of web page elements, while storage facility 608 stores the non-user-definable portions. Storage facilities 606 and 608 need not be separate physical storage devices. Storage facility 606 may be embodied by a database storing each of the user-definable portions of a semantic representation of a web page element in association with a user identifier and an element identifier. Storage facility 608 may store a set of dynamic semantic representation of web pages (i.e., web page definitions written in DHTML, CFML, or any other dynamic mark-up language). Processing node 602 is programmed to respond to a hypertext transfer protocol (http) request for a particular affiliate web page by assembling the web page, on an element-by-element basis, using the user-definable components and the non-user-definable components.

Processing node 604 is programmed to respond to an http request for a particular template web page, by first verifying that the user requesting the web page is authorized to re-define the web page (this can be done by requesting a user identifier and a user password) and then constructing the template to correspond to the particular affiliate web page to be edited. Processing node 604 is also programmed to respond to selection of a template element by prompting the user to redefine the definable aspect of the web page element corresponding to the selected template element. Processing node 604 then stores the newly defined component in storage facility 606. Processing nodes 602 and 604 need not be separate machines, and may be comprised of a single machine programmed to perform the above-described functionality.

FIG. 7 depicts a template web page in which some of the elements are non-definable with respect to a particular user. Returning to the example of the accounting firm for the sake of illustration, if a user identifies himself as a particular accountant within the accounting firm, then the template web page served to him would have certain template web page elements being selectable, but others being non-selectable. The banner 702, the menu 704, and the map 706 template elements are non-selectable to the accountant, because the accounting firm wants those elements to appear identically on every accountant's web page. However, the picture 708, practice description 710, and personal description web 712 page elements are selectable to the accountant, because they are used to personalize the page for the particular accountant. However, if a user were to identify himself as an administrator of the accounting firm, the banner 702, the menu 704, and the map 706 template elements would be selectable (to permit the accounting firm the ability to adjust the look-and-feel of each page generally).

Thus, to define a web page, a user first logs into processing node 604, identifying himself with a user identifier and a password. In response, processing node 604 constructs a template web page with the appropriate template elements being selectable. Upon selection of a selectable template element, processing node 604 prompts the user to redefine the definable aspect of the web page element corresponding to the selected template element. Processing node 604 then stores the newly defined component in storage facility 606.

FIG. 8A depicts a sequence of steps that processing node 604, in one possible embodiment of the invention, is programmed to execute, in order to inform a designated set of individuals that a particular affiliate web page has been changed, so that they might re-visit the page. To achieve this result, processing node 604 first waits a determined duration of time (for example, 24 hours), as depicted in operation 800. The duration of time for which the processing node waits may be definable by the user. After waiting the determined period of time in operation 800, control is passed to change determination operation 802, in which it is decided whether or not any aspect of any of the web page elements of a particular web page has been changed. In one embodiment, this operation may be accomplished by comparing a saved version of the user-definable components in storage facility 606 with a current version of the user-definable components stored therein. In another embodiment, this operation is accomplished by saving a last-changed datestamp along with each user-definable element in storage facility 606. Optionally, for each page, a datestamp indicating the last time and day upon which a user-definable element was changed may be stored. Thus, by examining either all of the datestamps associated with a page (one per user-definable element), or by examining a page-level datestamp, it can be determined if the affiliate web page has changed since the last time processing node 604 looked for changes to the page (for example, assuming the wait interval in operation 800 is 24 hours, the processing node 604 can test to determine if a datestamp is within the preceding 24 hours). If an element has been changed, then control is passed to viewer list notification operation 804. In viewer list notification operation 804, a notification communicating the fact that the web page has changed is e-mailed to a list of potential viewers of the web page. In one possible embodiment, the list of potential viewers may be established by the operator of the affiliate web page (for example, an accountant could provide a list of e-mail addresses for each of his clients). Thus, the list of potential viewers need not include actual past viewers of the web page, but rather may include any e-mail address designated by the operator of the affiliate page. Alternately, a set of potential viewers may be designated by means other than e-mail address and contacted by other means other than e-mail (for example, a set of potential viewers could be identified by pager numbers, and could be paged when a particular affiliate web page is changed). If, in change determination operation 802, it is determined that none of the web page elements of a particular web page have changed, then control is returned to wait operation 800.

FIG. 8B depicts a sequence of steps that processing node 604, in one possible embodiment of the invention, is programmed to execute, in order to inform an operator of an affiliate web page that his page has not been changed for a certain period of time. Within the context of the discussion relating to FIG. 8B, a web page is referred to as “stale” if it remains unchanged for more than a specified period of time, referred to as the “stale threshold”. The method of FIG. 8B begins by processing node 604 first waiting a determined duration of time (for example, 24 hours), as depicted in operation 806. The duration of time for which the processing node waits may be definable by the user, and may be different from the interval of time referred to in operation 806 of FIG. 8A. The period of time referred to in operation 806 is not the stale threshold itself, but rather is the periodicity with which processing node 604 checks to determine whether the stale threshold has been exceeded. After waiting the determined period of time in operation 806, control is passed to change determination operation 808, in which it is decided whether or not any aspect of any of the web page elements of a particular web page has been changed. In one embodiment, this operation is accomplished by saving a last-changed datestamp along with each user-definable element in storage facility 606. Optionally, for each page, a datestamp indicating the last time and day upon which a user-definable element was changed may be stored. Thus, by examining either all of the datestamps associated with a page (one per user-definable element), or by examining a page-level datestamp, it can be determined if the affiliate web page has changed within the stale threshold (for example, within the last 30 days). The stale threshold may be definable by the user. Processing node 604 can make this determination by testing to determine if a datestamp is within the stale threshold (for example, within the last 30 days). If a page-level date stamp or any of the datestamps for any of the user-definable elements on a web page are within the stale threshold, this indicates that the page has been changed recently, and control is returned to wait operation 806. If, on the other hand, a page-level datestamp or all of the datestamps for the user-definable elements on a web page fall outside of the stale threshold, control is passed to author notification operation 810, because the page is deemed to be stale. In author notification operation 810, an e-mail notification communicating that a particular affilate web page is stale is sent to the author of the web page (i.e., in the example of the accounting firm and the accountant, the accountant is notified that he has not changed his personal web page, if a certain period of time passes without his having done so). Alternately, the author of the web page may be telephoned, paged, or contacted by any other means. Finally, control is returned to wait operation 806.

The methods depicted in FIGS. 8A and 8B may be implemented as a single program or as separate programs, and may be executed by the same processing units or by different processing units.

FIG. 9A depicts a sequence of steps that processing node 604, in one possible embodiment of the invention, is programmed to execute, in order to permit a user to transmit an unprompted data transmission (such as an e-mail, or a transmission under the file transfer protocol, FTP) to the processing node 604 and thereby re-define his affiliate web page. Occasionally, a user may be connected to processing node 604 via a slow network connection, so that interfacing with it to re-define an affiliate web page is best done via a text-only transmission. Under such a circumstance, the user may send a structured e-mail that contains the modifications to be made to the affiliate web page to processing node 604. Thus, the template-based user interface is bypassed.

As shown in FIG. 9B, the e-mail message 900 sent to processing node 604 may comprise: a user identifier 901 that identifies the particular user and therefore employee/affiliate web page to be modified; a password 902 to verify the identity of the purported author of the e-mail; a web page element identifier 904 to identify the web page element to be re-defined; and, a textual string or other code 906 for redefining a web page element.

As shown in FIG. 9A, processing node 604 may be programmed to execute a set of operation permitting it to receive and process such a transmission as shown in FIG. 9A. Processing node 604 first waits a certain duration of time, as depicted in wait operation 908. Then, the processing node makes a determination, in query operation 910, whether or not a transmission that is intended to redefine an employee/affiliate web page has been received. If no such transmission has been received, control is returned to wait operation 908. If such a transmission has been received, control is passed to identity verification operation 912. In identity verification operation 912, processing node 604 reads the user identifier 901 and password 902 from the transmission, and determines whether or not the two properly correspond to each other. If they do not properly correspond, control is returned to wait operation 908. If they do properly correspond, control is passed to extraction operation 914. In extraction operation 914, the web page element identifier 904 and textual string or control code 906 are read from the transmission, and it is determined which web page element is to be re-defined. Finally, in storage operation 916, the textual string or control code 906 is stored in storage facility 606 and control is returned to wait operation 908. As stated earlier, by storing the textual string or control code 906 in storage facility 606, the next time processing node 604 services an http request for the employee/affiliate web page containing the modified web page element, it would assemble that web page element using the newly user-defined component (i.e., text string or control code 906), thus changing the appearance of web page element in the desired manner.

Although the description of the preferred embodiments is quite specific, it is contemplated that various modifications could be made without deviating from the spirit of the present invention. Accordingly, it is intended that the scope of the present invention be dictated by the appended claims, not the description of the preferred embodiments and methods.

The claimed invention is:

1. A system for providing an on-line forum for permitting at least one user to define a web page, the web page comprising a plurality of web page elements, the system comprising:
a computing complex accessible to the at least one user via a network, the computing complex having at least one processing node and at least one storage medium, wherein the at least one processing node is programmed to cooperate with the at least one storage medium to provide
a database storing data describing at least one of the plurality of web page elements comprising the web page; and
a first software module designed to produce a template representing the web page, the template comprising a plurality of template elements, each template element corresponding to one of the plurality of web page elements, each template element being selectable, the first software module being further designed to permit redefinition of a web page element corresponding to a template element, in response to the template element being selected.

2. The system of claim 1, wherein the first software module is further designed to permit redefinition of a web page element by altering the data describing the web page element stored in the database.

3. The system of claim 1, wherein the first software module is further designed to produce a semantic representation of the web page based in part upon the data stored in the database.

4. The system of claim 1, further comprising a second software module, the second software module being designed to produce a semantic representation of the web page based in part upon the data stored in the database.

5. The system of claim 4, wherein the at least one processing node comprises:
a first processing processing node programmed to cooperate with the at least one storage medium to provide the database and the first software module;
a second processing node programmed to cooperate with at least one of the at least one storage media to produce a semantic representation of a web page based in part upon the data stored in the database.

6. The system of claim 1, wherein the first software module is further designed to transmit an e-mail if the data describing the web page element stored in the database has not been changed for a specified period of time.

7. The system of claim 1, wherein the first software module is further designed to transmit an e-mail if the data describing the web page element stored in the database has been changed.

8. The system of claim 1, wherein the at least one processing node further comprises:
a second software module that receives an unprompted data transmission, and in response to the unprompted data transmission, draws data from the unprompted data transmission, storing at least a portion the data from the unprompted data transmission in the database, thereby redefining at least one web page element.

9. The system of claim 8, wherein the second software module that receives an unprompted data transmission comprises a second software module that receives an e-mail.

10. The system of claim 1, wherein the at least one user comprises at least two users, wherein the plurality of web page elements comprises a first set of web page elements and a second set of web page elements, and wherein the first software module is further designed to:
permit a first of the at least two users to redefine the first set of web page elements, but not the second set of web page elements; and
permit a second of the at least two users to redefine the second set of web page elements, but not the first set of web page elements.

11. A method of permitting at least one user to define a web page on line, the web page comprising a plurality of web page elements, the method comprising:
providing a database to store data describing at least one of the plurality of web page elements comprising the web page;
producing a template representing the web page, the template comprising a plurality of template elements, each template element corresponding to one of the plurality of web page elements, each template element being selectable; and
redefining a web page element corresponding to a template element, in response to the template element being selected.

12. The method of claim 11, wherein redefining a web page element comprises altering data describing the web page element stored in the database.

13. The method of claim 11, further comprising producing a semantic representation of the web page based in part upon the data stored in the database.

14. The method of claim 11, further comprising transmitting an e-mail if the data describing the web page element stored in the database has not been changed for a specified period of time.

15. The method of claim 11, further comprising transmitting an e-mail if the data describing the web page element stored in the database has been changed.

16. The method of claim 11, further comprising:
receiving an unprompted data transmission;
in response to reception of the unprompted data transmission, drawing data from the unprompted data transmission; and
storing at least a portion the data drawn from the unprompted data transmission in the database, thereby redefining at least one web page element.

17. The method of claim 16, wherein receiving an unprompted data transmission comprises receiving an e-mail.

18. The method of claim 11, wherein the at least one user comprises at least two users, wherein the plurality of web page elements comprises a first set of web page elements and a second set of web page elements, and wherein the method further comprises:
permitting a first of the at least two users to redefine the first set of web page elements, but not the second set of web page elements; and
permitting a second of the at least two users to redefine the second set of web page elements, but not the first set of web page elements.

19. A propagated signal on a carrier detectable by a computing system and encoding an e-mail message containing a sequence of data at least partially describing at least one web page element.

20. The propagated signal of claim 19, wherein the sequence of data comprises:
a user identifier; and
a password corresponding to the user identifier.

21. The propagated signal of claim 20, wherein the sequence of data further comprises:
a web page element identifier; and
a textual string for presentation on a web page.

22. A method of defining a web page on line, the web page comprising a plurality of web page elements, the method comprising:
displaying a template web page, the template web page comprising a plurality of selectable template web page elements, each template web page element corresponding to one of the plurality of web page elements comprising the web page;
selecting one of the plurality of template web page elements, causing a prompt to appear that permits redefinition of the web page element corresponding to the selected template web page element; and
redefining the web page element corresponding to the selected template web page element.

23. The method of claim 22, wherein the template web page further comprises one or more non-selectable template web page elements.
